(19) United States
(12) Patent Application Publication
(10) Pub. No.: US 2017/0337075 A1
(43) Pub. Date: Nov. 23, 2017

(54) IDENTIFYING PAGES IN A MIGRATION MANAGEMENT SYSTEM

(71) Applicant: International Business Machines Corporation, Armonk, NY (US)

(72) Inventors: Keerthi B. Kumar, Bangalore (IN); Shailaja Mallya, Bangalore (IN)

(21) Appl. No.: 15/409,904

(22) Filed: Jan. 19, 2017

Related U.S. Application Data
(63) Continuation of application No. 15/156,531, filed on May 17, 2016.

(51) Int. Cl. G06F 9/455; G06F 12/1009; G06F 9/50; G06F 12/1027

(52) U.S. Cl. CPC G06F 9/45558; G06F 12/1027; G06F 12/1009; G06F 9/5077; G06F 2009/45583; G06F 2212/65

(57) ABSTRACT

A computer-implemented method includes identifying a page. The page is associated with a request for migration. The page is associated with a current page address. The method includes determining whether the page is associated with a previous page. The previous page is associated with a previous page address. The method is responsive to the page not being associated with a previous page. The method responds by marking the page as being for migration. The method is responsive to the page being associated with a previous page. The method responds by determining whether the previous page has been written to. The method is responsive to the previous page having been written to by marking the page as being for a mapping migration. The method is responsive to the previous page having not been written to by marking the page as not being for migration.

### BACKGROUND

The present invention relates generally to the field of data storage management and more particularly to identifying pages in the context of a data storage management and migration system.

Data migration is the process of transferring data between storage types, formats, or computer systems. Data migration occurs for a variety of reasons, including server or storage equipment replacements, maintenance or upgrades, application migration, website consolidation, and data center relocation. Data migration systems may map data from a first system to a second system. Data migration may include the migration of individual memory pages, filesystem files, entire filesystems, database tables, entire databases, and applications including executable code together with data.

### SUMMARY

A computer-implemented method includes identifying a page. The page is associated with a request for migration. The page is associated with a current page address. The method includes determining whether the page is associated with a previous page. The previous page is associated with a previous page address. The method is responsive to the page not being associated with a previous page. The method responds by marking the page as being for migration. The method is responsive to the page being associated with a previous page. The method responds by determining whether the previous page has been written to. The method is responsive to the previous page having been written to by marking the page as being for a mapping migration. The method is responsive to the previous page having not been written to by marking the page as not being for migration. A corresponding computer program product and computer system are also disclosed.

### BRIEF DESCRIPTION OF THE DRAWINGS

FIG. 1 is a block diagram of an operational environment suitable for operation of a migration management program, in accordance with at least one embodiment of the present invention.

FIG. 2 is a flowchart depicting operational steps for a migration management program, in accordance with at least one embodiment of the present invention.

FIG. 3 is a flowchart depicting operational steps for a migration management program for delayed migration, in accordance with at least one embodiment of the present invention.

FIG. 4 is a block diagram of components of an operational apparatus suitable for executing a migration management program, in accordance with at least one embodiment of the present invention.

### DETAILED DESCRIPTION

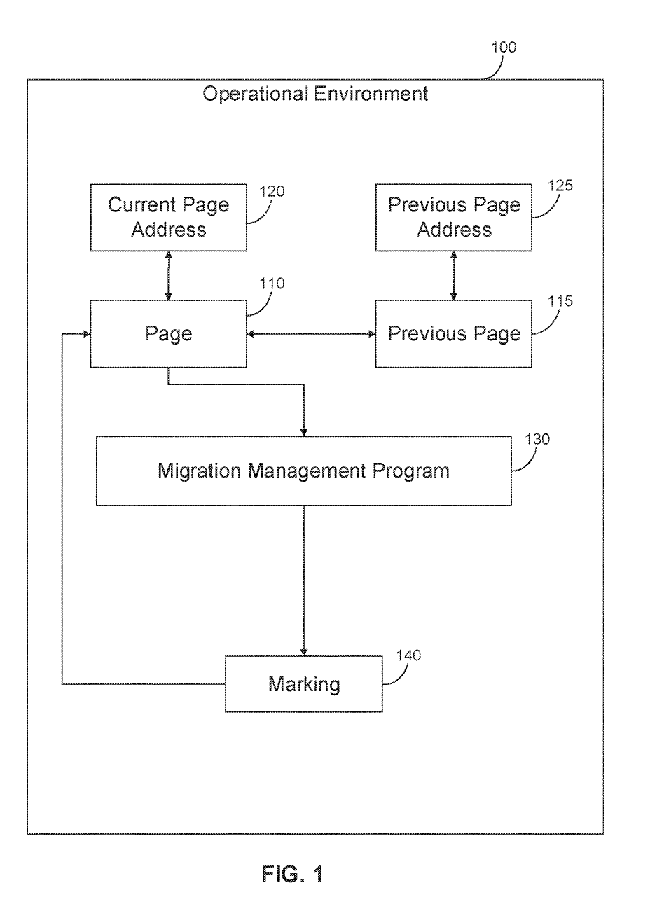

Referring now to the invention in more detail, FIG. 1 is a block diagram displaying an exemplary operational environment suitable for operation of at least one embodiment of the invention. An operational environment includes a page 110, a previous page 115, a current page address 120, a previous page address 125, a migration management program 130, and a marking 140, all in mutual communication and interconnected via the operational environment 100. The operational environment 100 may be a cloud-based, virtual, or distributed environment or a remote environment on defined server hardware, or, more generally, the operational environment 100 may be any type of environment suitable for access by the migration management program 130. The operational environment 100 may be a live partition migration system. A live partition migration system is a system for moving files from a running virtual machine or application between different physical or virtual machines without disconnecting the client or application. The operational environment 100 may be a virtual memory management system.

The page 110 is a page, memory page, or virtual page. In an embodiment, the page 110 is a fixed-length continuous block of virtual memory. The page 110 may be understood as the smallest unit of data for memory management in a virtual memory-enabled operating system. Embodiments based upon variable length pages are contemplated as well. The page 110 is associated with the current page address 120. The current page address 120 is a physical address, real address, and/or binary address. The current page address 120 may be represented as a binary number on an address bus circuitry, thereby enabling a data bus to access the page 110.

In an embodiment, the previous page 115 is a page, memory page, or virtual page similar to the page 110. The previous page 115 and the page 110 include the same data. The previous page 115 may be associated with a previous page address 125. The previous page address 125 is a physical address, real address, and/or binary address. The previous page address 125 may be represented as a binary number on an address bus circuitry in order to enable a data bus to access the previous page 115. In other embodiments, the previous page address 125 may be a virtual address, referring to an address that was once associated with the page 110, but is no longer associated with the page 110. For example, an example page may have a first address. The example page may then be transferred to another location in the context of a memory management system. When the example page is moved the example page is associated with a new address, the new address is analogous to the current page address 120. The first address may be understood as a virtual address for the example page and as analogous to the previous page address 125.

In some embodiments, the previous page 115 and the page 110 include the same data because the previous page 115 is a result of having been migrated from a first location to a second location. In such an embodiment, the previous page 115 includes the same data as the page 110, but is located at the second location whereas the page 110 is at the first location.

The page 110 and the previous page 115 may be for a page size management daemon, which may be understood as any process, function, or routine that performs the herein described properties in the context of the operational environment 100. A page size management daemon identifies pages, such as the page 110 and the previous page 115, for promotion and demotion based on a page size associated with the page 110 or the previous page 115. The page size management daemon may select pages for migration responsive to input from the migration management program 130.

In some embodiments, the page 110 is created as a result of the previous page address 125 is being used by a new page as a result of the page size management daemon. For example, the page size management daemon may re-use the previous page address 125 in the creation of a new page. In such an embodiment, this new page is the page 110.

The page 110 is associated with a request for migration. The request for migration may be responsive to user input. The request for migration may be based on a periodic back-up memory system. The request for migration may be associated with the page size management daemon. The request for migration may be directed to a live partition migration system. The live partition migration system may be a feature of, for example, IBM POWER6, IBM POWER7, and/or IBM POWER8. The page 110 may be associated with a virtual memory system. The virtual memory system may be for a running logical partition. A running logical partition is a subset of a computer's hardware resources, virtualized as a separate computer. In such an embodiment, the request for migration may be to migrate the running logical partition (known in the art as an “LPAR”) from a first computer system to a second computer system, that is, a live migration of the running logical partition.

In some embodiments, the request for migration includes a request to move the page 110 from a first location to a second location. In such an embodiment, the previous page 115 may be stored at the second location. In such an embodiment, determining whether the page 110 is associated with the previous page 115 may include only scanning the second location for a page similar to the page 110.

The migration management program 130 identifies the page 110, the page 115, and other pages in the context of a migration management system. Alternatively, the migration management program 130 may identify the page 110, the page 115, and other pages in the context of a live partition migration system. In other embodiments, the migration management program 130 may identify the page 110, the page 115, and other pages in the context of a virtual memory management system. The migration management program 130 is capable of receiving the page 110 and the previous page 115 as input and generating the marking 140 as output.

In an embodiment, the marking 140 is a tag, label, or indication that is attached to or otherwise associated with the page 110. The marking 140 is capable of being understood by a virtual memory management system, a live partition migration system, a migration management system and/or any system for migrating the page 110 and the previous page 115. The marking 140 may be an instruction or series of instructions capable of being understood by a virtual memory management system, a live partition migration system, a migration management system and/or any system for migrating the page 110 and the previous page 115. The marking 140 may be instructions to migrate the page 110. The marking 140 may be instructions to migrate the page 110 via a mapping migration. The marking 140 may be instructions to migrate the page 110 via a delayed migration. The marking 140 may be instructions to not migrate the page 110.

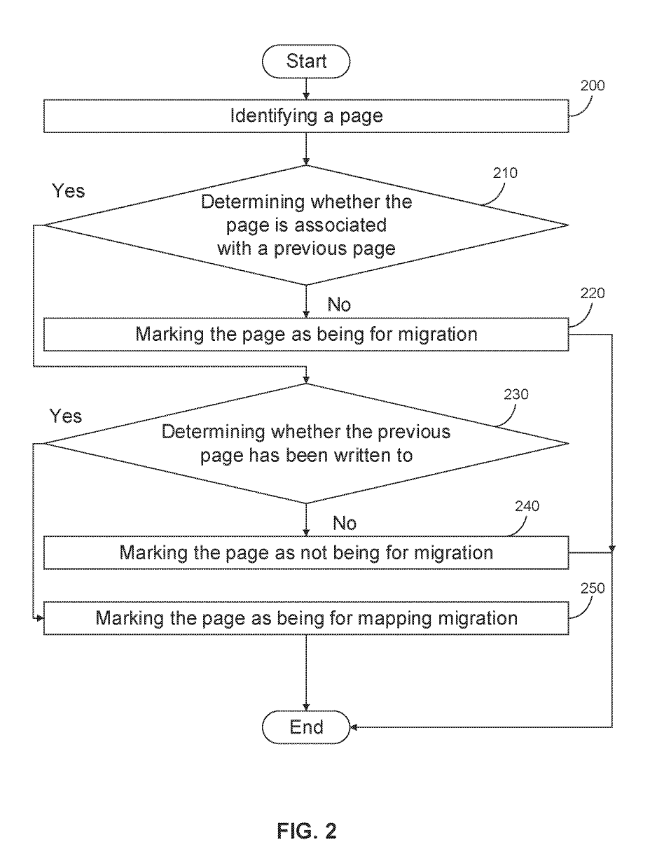

FIG. 2 is a flowchart depicting the operational steps of the migration management program, executing within the operational environment 100 of FIG. 1, in accordance with an embodiment of the present invention.

At step 200, the migration management program 130 identifies the page 110. The page 110 is associated with the current page address 120. Identifying may include a user explicitly calling the migration management program 130 from a command line interface using a reference to the page 110 as an argument. Alternatively, receiving may include automated calls to the migration management program 130, for example, from an integrated development environment or as part of a migration management system.

At step 210, the migration management program 130 determines whether the page is associated with a previous page, such as the previous page 115. Determining may include the migration management program 130 attempting to identify the previous page 115. In such an embodiment, if the migration management program 130 is able to identify the previous page 115, the migration management program 130 will determine that the page 110 is associated with a previous page. If the migration management program 130 is not able to identify the previous page 115, the migration management program 130 will determine that the page 110 is not associated with a previous page. In some embodiments, the migration management program 130 may scan all pages being migrated by a live partition migration system. In such an embodiment, the migration management program 130 may parse all pages to determine if any pages have the same filename, or include the same data as the page 110. In some embodiments, the same filename is with respect to filesystem pages. In such an embodiment, identifying a different page, such as the previous page 115, with the same file name and/or the same data as the page 110, means the migration management program 130 determined that the page 110 is associated with a previous page.

In some embodiments, determining whether the page 110 is associated with the previous page 115 is based on a hypervisor translation table. A hypervisor translation table is a structure that resides within a hypervisor entity. A hypervisor is a virtual machine monitor that operates in the context of an operating system. The hypervisor translation table will use the page 110, data from the page 110, the current page address 120 and/or the previous page 115, data from the previous page 115, and the previous page address 125. In such an embodiment, the hypervisor translation table will store information about the page 110 and the previous page 115 as a tuple of two. Using information in the hypervisor translation table the migration management program 130 may categorize whether or not the page is associated with a previous page and whether or not the previous page has been written to.

If the migration management program 130 determines that the page 110 is not associated with a previous page, the migration management program 130 proceeds to step 220. At step 220 the migration management program 130 generates a marking for the page 110, such as the marking 140, indicating that the page 110 is for migration. The migration management program 130 may mark the page 110 for migration if it was a new page or a page that was already sent and written to again. If the page 110 was not changed, it will be marked for delayed migration.

If the migration management program 130 determines that the page 110 is associated with a previous page, the migration management program 130 proceeds to step 230. At step 230, the migration management program 130 determines whether the previous page has been written to.

Determining whether a previous page has been written to includes determining whether there are differences between the page 110 and the previous page 115. Determining may include comparing data from the page 110 and the previous page 115. If there are no differences between the data included in the page 110 and the previous page 115, then the migration management program 130 may determine that the previous page 115 has not been written to.

In some embodiments, the page 110 may be associated with a request for migration to migrate the page 110 from a first location to a second location. In such an embodiment, the determination made by the migration management program 130 at step 210 may be based on whether or not the previous page 115 is stored at the second location. If for example, the previous page 115 were stored at a third location, but not at the second location, the migration management program 130 would determine that, no, the page 110 is not associated with the previous page 115. In such an embodiment, the migration management program 130 may determine whether the previous page 115 has been written to by identifying the previous page 115 from the second location and comparing data from the previous page 115 to data from the page 110.

In some embodiments, the migration management program 130 may determine whether the previous page 115 has been written to by comparing a most recent timestamp associated with the previous page 115 and determine if the most recent timestamp associated with the previous page 115 is after a timestamp associated with migration. In some embodiments, the migration management program 130 may determine whether the previous page 115 has been written to by analyzing the contents of the page 110 and the previous page 115. In some embodiments, the migration management program 130 may determine whether the previous page 115 has been written to via a checksum of the previous page 115.

If the migration management program 130 determines that, no, the previous page 115 has not been written to, the migration management program 130 proceeds to step 240. At step 240 the migration management program 130 generates a marking for the page 110, such as the marking 140, indicating that the page 110 is not for migration. The migration management program 130 may mark the current page for migration if it has been written to.

If the migration management program 130 determines that, yes, the previous page 115 has been written to, the migration management program 130 proceeds to step 250. At step 250 the migration management program 130 generates a marking for the page 110, such as the marking 140, indicating that the page 110 is for a mapping migration. A marking for a mapping migration includes a mapping between the previous page address 125 and the current page address 120. For example, the marking for a mapping migration may show a pathway from the previous page address 125 to the current page address 120. In other embodiments, the marking for a mapping migration may should a pathway from the current page address 120 to the previous page address 125. The migration management program 130 may mark both the current page and the previous page for migration at step 250.

In some embodiments, mapping migration includes the migration management program 130 identifying that a page, such as the page 110, has been moved. In such an embodiment, the migration management program 130 may respond to the page having been moved by determining whether or not the live partition migration system where the page is stored is under migration and/or marked for migration. If yes, the live partition migration system where the page 110 is stored is under migration and/or marked for migration, the migration management program 130 may retrieve a previous address for the page 110, such as the previous page address 125. The migration management program 130 may then update the hypervisor translation table to include the previous page address 125. If no, the live partition migration system where the page is stores is not under migration and/or marked for migration, the migration management program 130 will not update the hypervisor translation table.

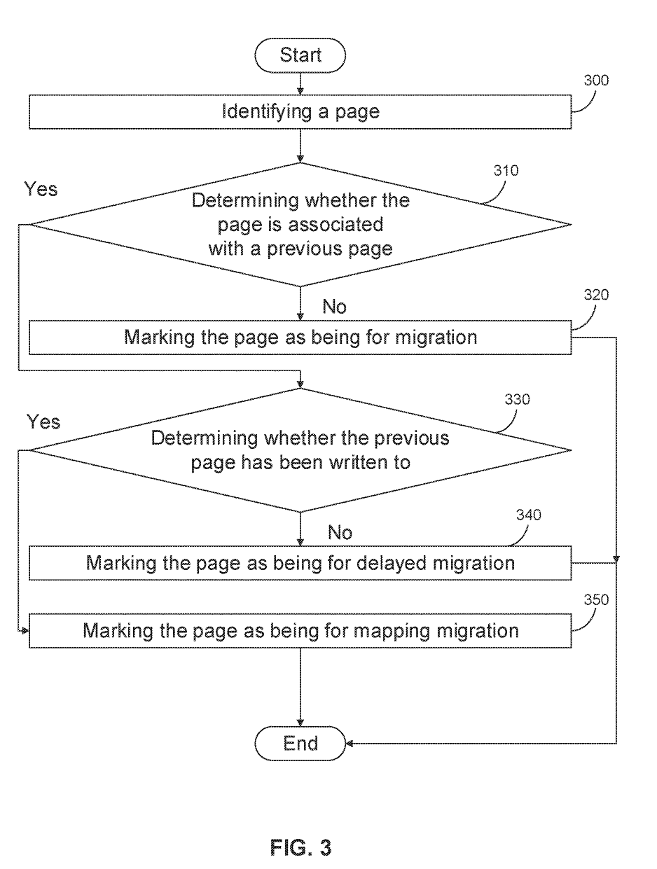

FIG. 3 is a flowchart depicting operational steps for the migration management program 130 for delayed migration, in accordance with at least one embodiment of the present invention.

The migration management program 130 performs step 300, step 310, step 320, step 330, and step 350 in a manner similar to step 200, step 210, step 220, step 230, and step 250.

At step 320, the migration management program 130 may mark the page for migration if it was a new page or a page that was already written to. If the page was not changed, it will be marked for delayed migration.

At step 350, the migration management program 130 may mark both the current and previous page for migration.

The migration management program 130 responds to determining whether the previous page 115 has been written to or not (step 330). If no, the previous page 115 has not been written to, the migration management program 130 proceeds to step 340. At step 340, the migration management program 130 generates a marking, such as the marking 140, indicating that the page 110 is for delayed migration. Delayed migration may include instructions to only migrate the page 110 after a system using the page 110 is frozen, inactive, off, or otherwise not performing other functions. At step 240, the migration management program 130 may mark the previous page as being for delayed migration.

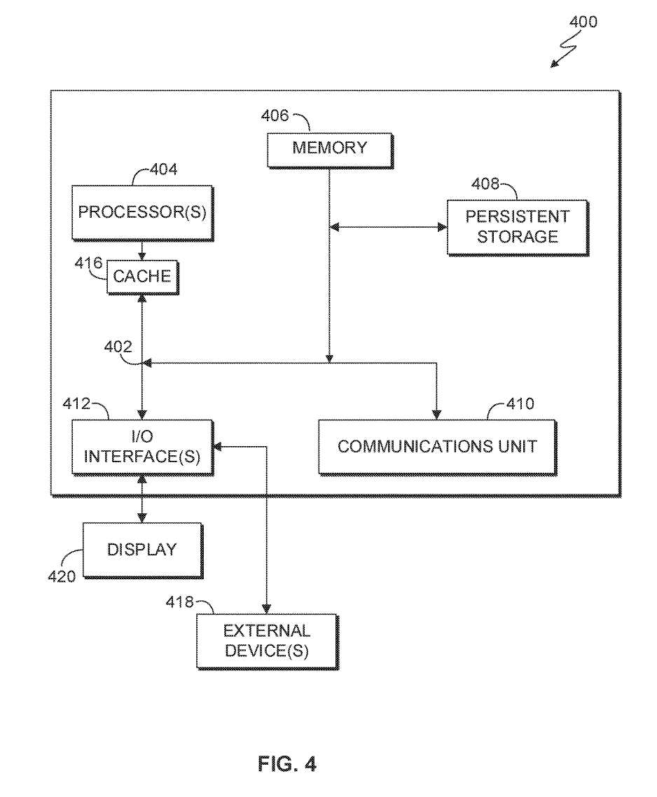

FIG. 4 is a block diagram depicting components of a computer 400 suitable for executing the migration management program 130. FIG. 4 displays the computer 400, the one or more processor(s) 404 (including one or more computer processors), the communications fabric 402, the memory 406, the RAM 416, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the migration management program 130 may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The migration management program 130 may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
identifying a page, said page being associated with a request for migration, said page being associated with a current page address;
determining whether said page is associated with a previous page, said previous page being associated with a previous page address;
responsive to said page not being associated with a previous page, marking said page as being for migration;
responsive to said page being associated with a previous page, determining whether said previous page has been written to;
responsive to said previous page having been written to, marking said page as being for a mapping migration;
responsive to said previous page having not been written to, marking said page as being for delayed migration;
wherein said mapping migration comprises a mapping between said previous page address and said current page address;
wherein determining whether said page is associated with a previous page is based on a hypervisor translation table;
wherein the hypervisor translation table comprises a two-tuple indicator that indicates whether said page is associated with the previous page and whether the previous page has been written to;
wherein said request for migration is directed to a live partition migration system;
wherein said page is associated with a virtual memory system for a running logical partition; and
wherein said request for migration is to migrate said running logical partition from a first computer system to a second computer system.
